(19) United States
(12) Patent Application Publication
(10) Pub. No.: US 2006/0263258 A1
(43) Pub. Date: Nov. 23, 2006

(54) Automated biological indicator incubator

(76) Inventors: Matthew Harris, Twin Lakes, WI (US); Gregory O. Stecklein, Lake Villa, IL (US); Karl J. Kobel, Wildwood, IL (US); John E. Prey JR., Tower Lake, IL (US)

Correspondence Address: Kimberly Luna;Allegiance Corporation, 1430 Waukegan Road, McGaw Park, IL, 60085, US

(21) Appl. No.: 11/349,633

(22) Filed: Feb. 8, 2006

Related U.S. Application Data
(60) Provisional application No. 60/651,815, filed on Feb. 10, 2005.

(51) Int. Cl. B01L 9/00

(52) U.S. Cl. 422/99

(57) ABSTRACT

A system and method of automated incubating and reading of biological indicators is disclosed. In one embodiment, the automated biological indicator incubator is configured to control the temperature of incubation test wells to a desired temperature range suitable for use with a biological indicator, control the incubation period, and detect a change in the biological indicator colored media providing an indication of growth or lack of growth. In other embodiments, the automated biological indicator incubator is self-calibrating, and provides a communication interface to an external device, such as a computer. The communication interface is suitable for use to collect and analyze data associated with the biological indicator during the incubator period, and for making a determination of growth or lack of growth and success of the sterilization process as well as a permanent document of the monitoring of the sterilization process.

### CROSS-REFERENCE TO RELATED APPLICATIONS

This non-provisional application claims the benefit of the filing date of Provisional U.S. Patent Application Ser. No. 60/651,815, entitled “AUTOMATED BIOLOGICAL INDICATOR INCUBATOR,” having Attorney Docket No. C270.101.101, and having a filing date of Feb. 10, 2005, and which is herein incorporated by reference.

### THE FIELD OF THE INVENTION

The present invention generally relates to an incubator employed for reading biological indicators, and more particularly, a system and a method employing an automated incubator for incubating and reading biological indicators, and performing other functions associated with the reading of biological indicators.

### BACKGROUND OF THE INVENTION

Biological indicators are used to determine the efficacy of sterilization. In conventional clinical processes, a test organism is coated on a carrier (e.g., a spore strip). The coated carrier is placed in a carrier vial with an ampule of media. The media promotes the growth and recovery of the test organism as well as provides a pH based visual trigger if growth were to occur. This combined clinical indicator vial is then sealed (e.g., using a cap) to protect it from environmental contamination while allowing targeted sterilization energy to penetrate. This self-contained biological indicator (spore strip, ampule, outer vial and sealed cap) is placed in a sterilizer with the article to be sterilized (for testing & validation purposes) or more generally packaged in another known resistance vessel (PCD or test pack) to be placed along with the article to be sterilized. After sterilization, the self-contained biological indicator is then activated by crushing the ampule to expose the growth and indication media to the spore strip and placed in a biological indicator incubator to determine whether any of the test organism survived the sterilization procedure.

The biological indicator incubator provides a controlled environment for organism growth by holding the test organism at a temperature that supports organism growth. Commercially available biological indicators visually indicate spore growth or spore inactivation that is correlated to a sterility assurance level through a color change (or lack of color change) after a sufficient incubation period. While this color change may occur over time, the span of time required is generally beyond a clinical users ability to monitor and report in an efficient manner.

There is a need for a biological indicator incubator that provides for simple, dependable, automatic readout of self-contained biological indicators after an incubation period, along with other characteristics associated with the incubation and readout of biological indicators.

### SUMMARY OF THE INVENTION

The present invention provides an automated biological indicator incubator. In one embodiment, the present invention provides an automated biological indicator incubator configured to control the temperature of incubation test wells to a desired temperature range suitable for use with a biological indicator, control the incubation period, and detect a change in the biological indicator colored media providing an indication of growth or lack of growth. In other embodiments, the automated biological indicator incubator is self-calibrating, and provides a communication interface to an external device, such as a computer. The communication interface is suitable for use to collect and analyze data associated with the biological indicator during the incubator period, and for making a determination of growth or lack of growth and success of the sterilization process as well as a permanent document of the monitoring of the sterilization process.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a diagram illustrating one embodiment of an automated biological indicator incubator according to the present invention.

FIG. 2 is a diagram illustrating an internal view of an automated biological indicator incubator.

FIG. 3 is a diagram illustrating one embodiment of a partial view of an automated biological indicator incubator, including a diagram of the optical path through the heater block.

FIG. 4 is a block diagram illustrating one embodiment of an automated biological indicator incubator according to the present invention.

FIGS. 5-19 are diagrams illustrating exemplary display screens used in the automated incubator of the present invention.

FIG. 20 is a table illustrating one embodiment of results via the incubator displays and alarms.

FIGS. 21-24 are diagrams illustrating exemplary display screens used in the automated incubator of the present invention.

FIG. 25 is a graph illustrating one exemplary embodiment of typical growth response.

FIG. 26 is a diagram illustrating one exemplary embodiment of automated incubator growth response capability.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

Embodiments of the present invention provide an automated biological indicator incubator for simple, dependable, automatic readout of self-contained biological indicators after an incubation period, along with providing other characteristics associated with the incubation and readout of biological indicators.

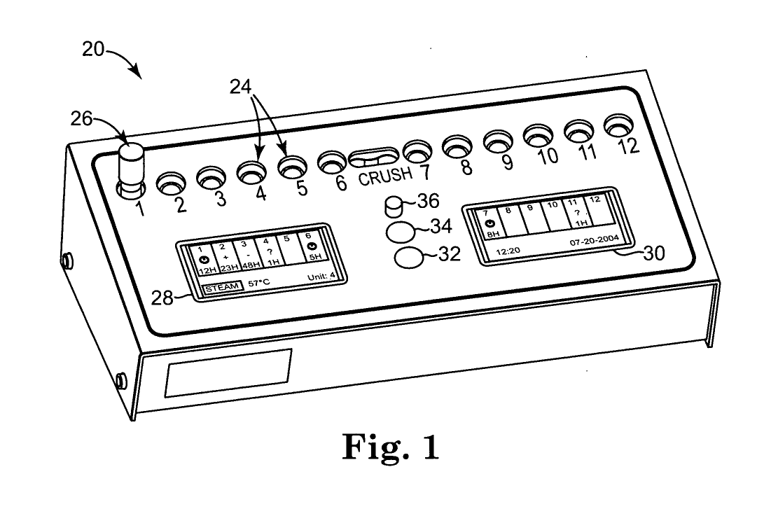

FIGS. 1 illustrates one exemplary embodiment of an automated incubator, suitable for use with biological indicators, according to the invention generally at 20. Automated incubator 20 is configured to control the temperature of the incubation test wells to a desired temperature range suitable for use with a self-contained biological indicator, control the incubation period, and detect a change in the biological indicator colored media through the measurement of light intensity as it is passed through the indicator. The automated incubator provides an indication of growth or lack of growth, and an outcome of the sterilization process. In other embodiments, the automated incubator is self-calibrating, and provides a communication interface to an external device, such as a computer. The communication interface is suitable for use to collect and analyze data associated with the biological indicator during the incubator period, and for making an automated determination of growth or lack of growth.

In one embodiment, automated incubator 20 includes one or more incubation test wells 24 (1-12 illustrated) for holding biological indicator vials 26 (one illustrated) to be tested. Automated incubator 20 also includes other control devices for operation of the incubator 20, such as the visual control displays 28 and 30, control buttons 32 and 34, and visual indicator 36 (e.g., an LED). One embodiment of automated incubator 20 and the operation of automated incubator 20 is described in further detail in the following paragraphs.

Temperature Control

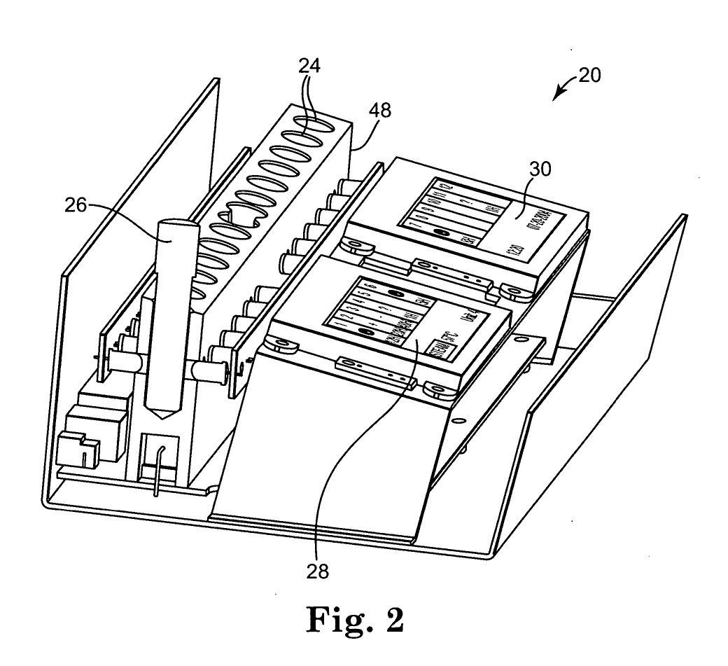

In reference also to FIG. 2, the automated incubator 20 is configured to control the temperature of the incubation test wells 24 to an acceptable temperature range, as well as time the incubation period. In one embodiment, the acceptable temperature range is around either 37 or 57 degrees C.

Automated incubator 20 is programmable to operate at different temperature settings (e.g., two different temperature settings) by controlling the temperature of heater block 48 (illustrated in FIG. 2) at incubation test wells 24. The set temperature for EO is 37° C., with a target range of 35° C.-39° C., and the STEAM setting is 57° C., with a target range of 55° C.-60° C. In one embodiment, the temperature is measured with a temperature sensor. In one embodiment, the temperature sensor is a single chip temperature sensor with serial output. The temperature sensor is trimmed at the die level to read within ±1.5 degree C. maximum of the absolute temperature value. The resolution of the device is within 0.0625 degrees C. The high accuracy allows the system to stay within the allowed 35 to 39 degree C. band, or the 55 to 60 degree C. band, without factory calibration, to insure proper incubation of the biological indicator. A small offset is applied to the read value to compensate for the thermal losses through the printed circuit board (PCB). The incubator heater block 48 may be further insulated to increase the control and resolution of the device.

Optical Detection System

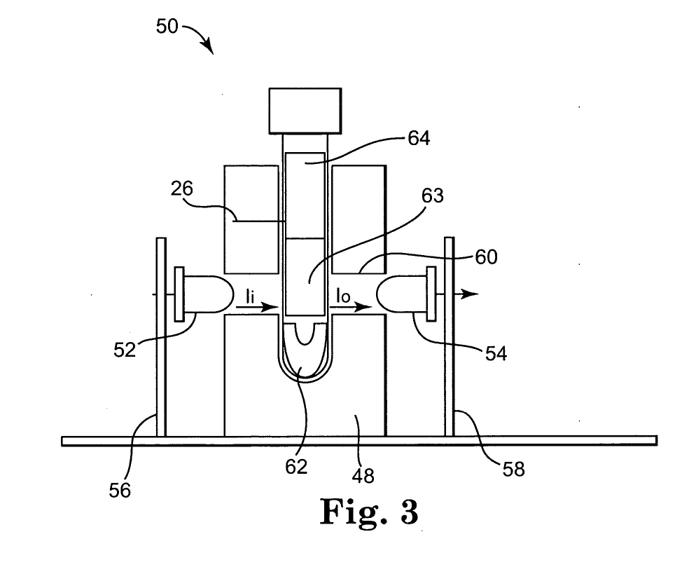

FIG. 3 is a partial diagram illustrating one embodiment of an optical detection system 50 for use with an automated incubator 20 according to the invention. Automated incubator 20 utilizes optical detection system 50 to detect a color change (e.g., dark to light color change) in the biological indicator colored media through the measurement of light intensity passed through the test biological indicator vial being evaluated. The optical detection system 50 includes a point light source 52 (e.g., an LED), a photo-detector 54, PC boards 56, 58, and guide hole 60. Biological indicator vial 26 is positioned in test well 24, having spore strip 62 and media 63.

The detection system 50 operates by measuring the light output change on photo-detector 54 received from light source 52. On side (a first side) of the biological indicator (BI) vial 26 there is a yellow LED 52 (Ii) (588 nM) placed about half way up, above BI spore strip material 62 and below information label 64. On the other side (a second side) of the BI vial 26, opposite the LED 52, is photo detector 54 to read the light level (Io). The LED 52 and detector 54 are mounted to PC boards 56,58 on each side of the BI holder, test well 24.

For each test well 24, a LED 52 and photo-detector 54 are captured in a drilled guide channel or hole 60. The guide hole 60 precisely aligns the emitter LED 52 with the detector LED 54. The guide holes 60 also operate to eliminate stray light from affecting the measurement.

Control System

Incubator 20 is configured to communicate with internal and external output devices, and has the ability to send and receive queries, receive inputs, generate outputs, etc. FIG. 4 is a block diagram illustrating one embodiment of incubator 20. Incubator 20 includes control system 100 having communications devices/module 102. Control system 100 communicates with optical detection system 50, including heater block 48 and temperature control 103 coupled to temperature sensor 105. Further, control system 100 communicates with interfaces 28, 30, and external devices such as graphical user interface 104 illustrated. In one embodiment, control system 100 is employed via system hardware and system software.

The automated incubator control system 100 is configured so that only one LED is on at a time, to avoid any cross talk with any of the other channels. In one embodiment, each channel is turned on for about 4 milliseconds in sequence. This is done once each second to insure that the system knows if the tube is in place and knows how long it has been there. The resulting signal is used to verify that a tube is present as well as determine if a color change has occurred and if that color change is appropriate.

Calibration

System 50 is self-calibrating by continually measuring the intensity of the LED 52 when no BI vial 26 is in place. This value is stored in memory as the full-scale calibration value. The detector 54 is also read when the LED 52 is off to set the zero level, also known as the dark current. Knowing these two values, the other levels (BI vial present, and the positive BI color change point) can be computed from stored values in the program, and properly scaled for the detection points.

Other factors keep the system accuracy high. In one embodiment, the current to the LED 52 is controlled by a constant current source. The constant current source keeps the output of the LED 52 at a constant level, since the LED 52 is held at a constant temperature. The signal is adjusted by a 4-bit A to D converter to one of 15 levels. This allows the detector 54 signal to be scaled to utilize the maximum range of the detector without saturating the system. This is important since the LED 52 light output and detector 54 sensitivity can vary by over 200% to 300% each. Increases in control and scalability can be realized by increasing the D to A converter to successively higher bit sensitivities (8-bit, 16-bit) to better overcome the light output variances of LED 52 and detector 54.

Another factor for creating a high stability system is having the A to D converter referenced to the same power supply as the constant current source for the LED's. The resulting readings are also averaged over several conversion cycles to insure high accuracy. The multiple readings are superior to a single reading since any one reading could be in error due to system noise or ESD or any other type of disturbance.

Additionally, because the LED's and detectors are contained in the heated block, and reasonably insulated from the external environment, their parameters remain stable, since they are operating in a stable environment. Since the system has calibration between each BI vial placement and continuous zero calibration, along with a fixed temperature for the optics, and ratio-metric analog circuitry, system stability remains very high.

Calibration Process

In one embodiment, during the last 30 to 60 seconds of warm-up, the control system (e.g., via software) checks each test well 24 for BI (BI vial 26) presence (i.e., well filled). If no BI vial 26 is detected, and the accumulated, and normalized, average of the last N values is within ±5 counts of the current value, the LED current is set to the maximum value, and the “through” (empty, light-on) value is read from the A to D converter. If the value is above 1000 (1023 being the highest value possible), the LED current is stepped down one level. This stepping down is done, for each well, until each value is below 1000 and above 650. If the value drops below 650, the LED current is stepped up one level. At the same time, the “zero” is read by reading the detector with the LED off.

Once the LED/detection pair is out of saturation (below 1000), the BI detect (well filled) and yellow (growth) detection levels are calculated using the “just out of saturation” or Max value determined above. One set of possible or currently preferred ratios are:

| Method | Range |
|---|---|
| Max = Saturation | (<1000, >650) |
| Min = Dark | (>0) |
| Filled = 3 * Max/5 | (<600, >390) |
| Growth = Max/7 | (<142.8, >92.8) |

This “calibration” is done for each empty well, every second to account for changes in LED intensity and detector sensitivity over changes in temperature and component aging.

The value used for calibration is normalized and averaged. The last ten readings are stored in a buffer. The buffer is sorted high to low and the two highest, and two lowest values are discarded. The middle 6 values are summed and divided by 6 to produce the average.

In another embodiment, the above configuration was compared with a second one where the light was read back from the same side as the illuminator LED, using the reflective properties of the fluid and to investigate the ability to read from a colorimetric baseline comparative of a non-opaque indicator.

Another embodiment also added a second LED. This LED was a violet color (405 nM) to match the negative BI color. The violet color change from negative to a positive BI was not very high, as compared to the yellow color change.

An alternative embodiment to the LED's utilized would increase the angle of light emission and detection. The purpose of this alternative embodiment is to increase the range of visible signal to potentially account for any localized intensity blockage due to label or spore strip location as well as the effects of glass shard light dispersion.

In another embodiment, the automated incubator also includes a wireless communication module and is configured for wireless communication with external devices (e.g., a computer). Further, the automated incubator can include a scanner module for scan-in capability of items such as barcodes and RFID transmitters.

In another embodiment, the automated incubator includes a “colorimeter” slot and module (i.e., similar to a credit card reader) that can assess the completeness of an external card's sterilization sensitive ink color change. In this embodiment, light may be reflected and compared against a base value to assess an acceptable color range.

Example Operation

The following paragraphs illustrate one exemplary embodiment of operation of the automated incubator 20. Reference is also made to FIGS. 1-4. The automated incubator 20 controls the temperature of the incubation test wells 24 to an acceptable temperature range of typically used clinical biological indicators, centered around either 57° C. (Steam) or 37° C. (EO), as well as time of the incubation period, and detect a change in the biological indicator colored media providing an indication of growth or lack of growth. The automated incubator 20 (via control system 100) constantly checks and calibrates itself and reports any lack of control as a fault condition. The incubator 20 also contains two external interfacing data ports (e.g., RS-232 and USB) that allows for the 2-way transmission of data (input and output) to an external device, such as a personal computer.

Two displays 28, 30 (LCD screens) that are incorporated into the face of incubator 20, one for the left six incubation wells 24 (wells 1-6) and one for the right six incubation wells 24 (wells 7-12). The “main” or primary screen is the LCD display 28 on the left hand side of the unit. Two buttons 32, 34 are centered between the LCD display screens 28, 30; both buttons 32, 34 are used according to the directions given on the left LCD screen during set-up and operations. The top button also serves as the alarm silence button. Above the two buttons is an LED 36, that provides a visual correspondence to system operations, outputs and alarms.

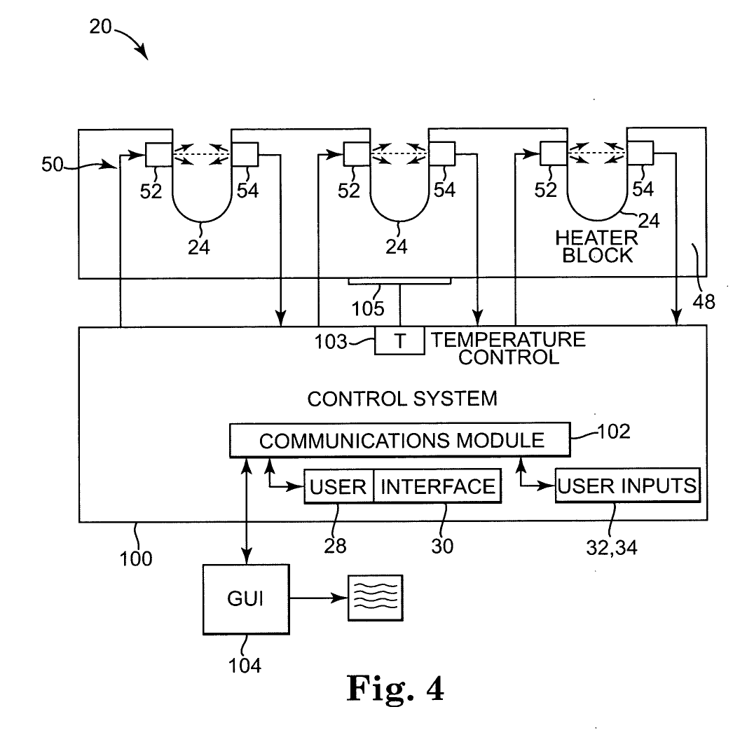

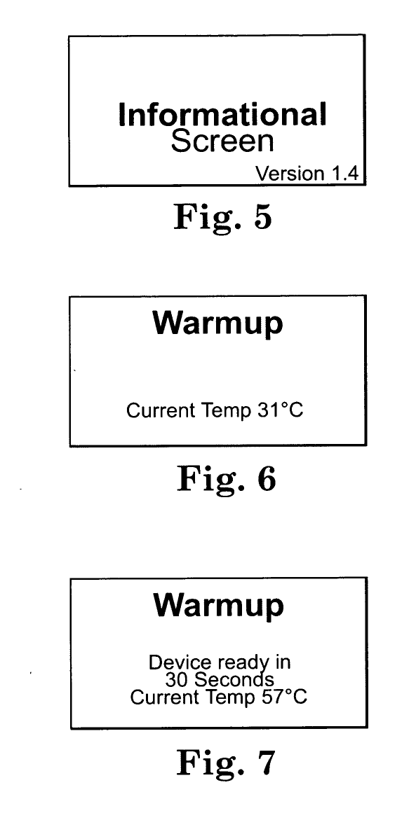

FIG. 5 and FIG. 6 illustrate one embodiment of displays 28 and 30 at power-up. At power-up there is a series of informational screens (FIG. 5). After the power-up sequence, the incubator 20 performs a series of internal tests and starts a temperature ramping process via control system 100 and heater block 48. A warm-up screen is displayed, indicating the temperature of the unit (FIG. 6). In one embodiment, after the temperature of the unit is in range of the selected temperature, the screen of FIG. 7 is displayed in display 28.

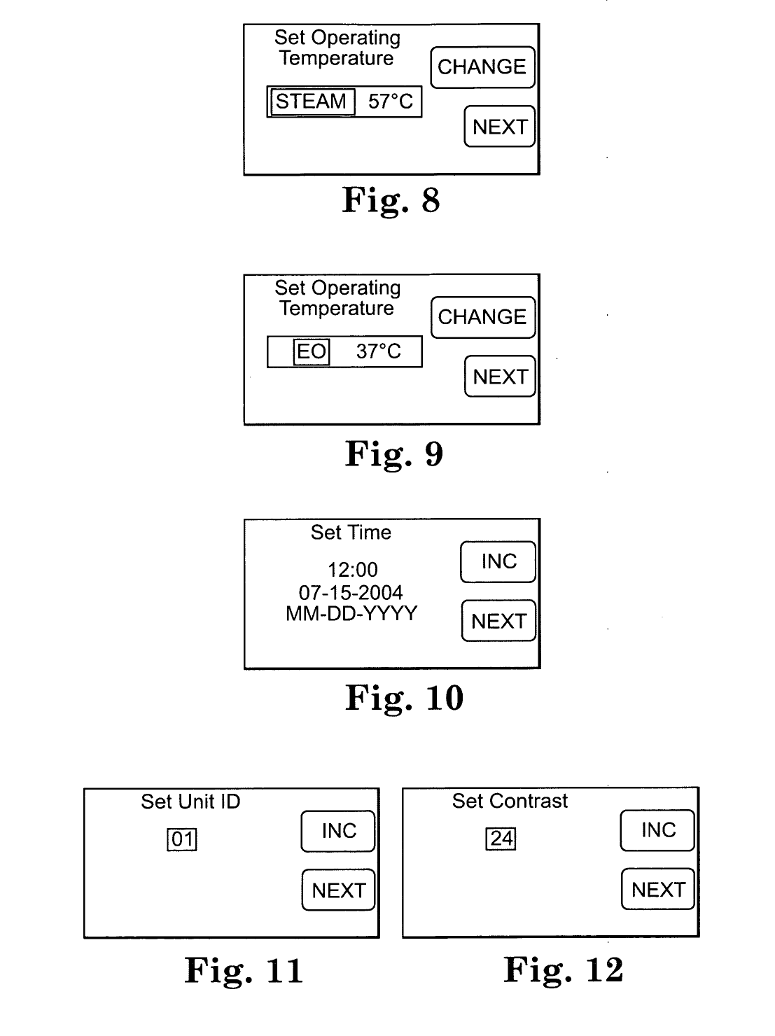

FIG. 8 and FIG. 9 illustrate one embodiment of display screens for operating temperature selection. In one embodiment, the system settings of the incubator can be entered or changed by pressing, and holding both buttons 32, 34 for a programmed time (e.g., 3 seconds). The incubator 20 is programmable to operate over two different temperature ranges corresponding to organisms typically exposed to STEAM (moist heat sterilization), EO (ethylene oxide gas stelization), sterilization. The STEAM target temperature is 57 degrees C. with an acceptable range of (55 degrees C.-60 degrees C.). The EO target temperature is 37 degrees C. with an acceptable range of (35 degrees C.-39 degrees C.). A “temperature fault” system failure is generally not noted until approximately 3 degrees C. below the lower range limit to allow the chance for system recovery prior to shutdown. The temperature selection screen will allow the operator to select the temperature range by pressing the change button. Pressing “Next” will accept the display choice and move to the next screen.

FIG. 10 is a diagram illustrating one embodiment of a screen used for setting time and date. When the operating temperature selection is complete, a screen will display to allow the real-time clock to be set. Pressing the INC button increments the highlighted field. Pressing NEXT will move the highlight to the next field. Pressing NEXT on the year will move to the next screen.

FIG. 11 illustrates one embodiment of setting the unit identification. When the set time and date is complete, a screen will display to allow the unit identification to be set. Pressing the INC button increments the highlighted fields. Pressing NEXT will accept the display choice and move to the next screen. Since the incubator is configured to have a unique unit identification code, the unit identification allows for the differentiation of multiple incubator units located at the same facility or location.

FIG. 12 is a diagram illustrating one embodiment of a display screen used for setting display contrast. When the unit identification is complete, a screen will display to allow the display contrast to be set. Pressing the INC button increments the highlighted field. Pressing NEXT accepts the displayed choice and moves to the main screen or the warm-up screen, depending on which screen was active when the setup screens were entered. Alternatively, a computer (PC) based program can externally communicate these inputs as a means of bypassing the need for user inputs.

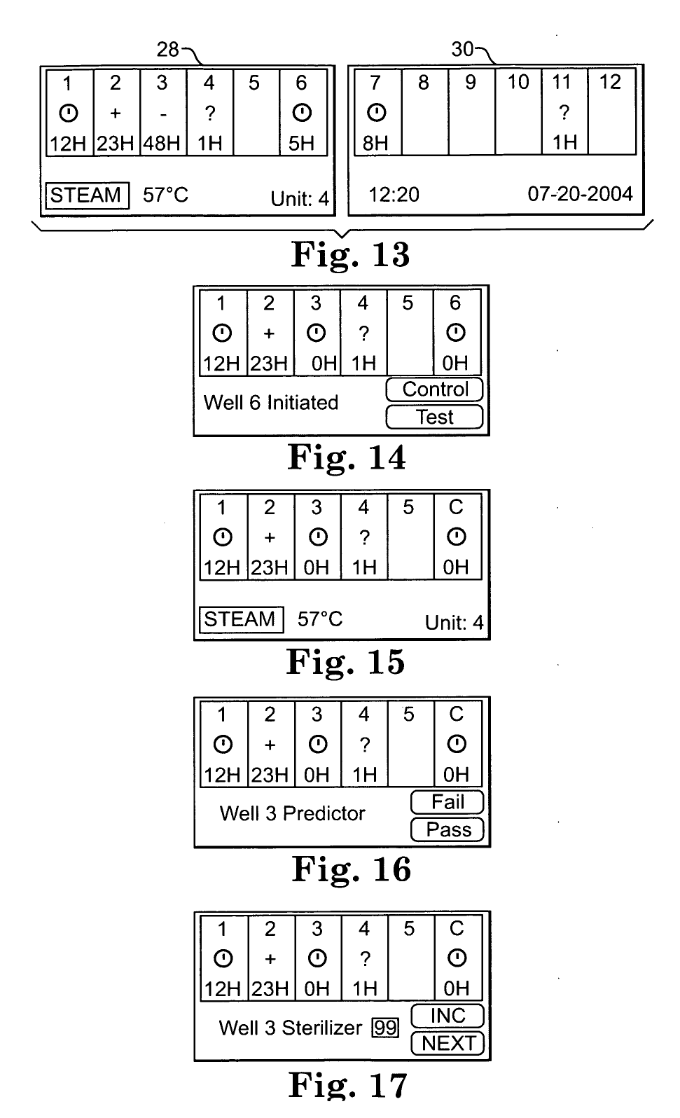

FIG. 13 illustrate one exemplary embodiment of the main display screens 28 and 30. After warm-up is complete, the incubator unit's LCD panels will display the running operation screens. Each LCD operation screen display 28, 30 is broken up into 6 boxes each representing one of the Biological Indicator testing wells 24. The data in the box will show the status of each testing well. The subline below the biological indicator testing well boxes displays standard operating settings (e.g., usage/temperature setting, Unit ID, Time and Date) as well as system queries during normal operations.

The lower portion of each BI testing well box displays the incubation time for the well represented. When the test is complete, the time indication will remain displayed until the results are confirmed and the biological indicator is removed from the well. If there is no biological indicator vial in the well, this portion will be blank.

The middle portion of each biological indicator testing well box displays the status of the well. If there is no vial in the well, this portion will be blank. If the vial has been placed in the well and the test is running, a clock icon will be displayed. The clock icon is animated to highlight its status as actively testing or “Testing in Progress.”

After a result is determined, a plus, minus or “?” icon will be displayed.
+: Indicates an actionable change in the BI being evaluated.
−: Indicates no actionable change in the BI being evaluated
?: Indicates the detectable change in the BI being evaluated was outside determined limit.

If a biological indicator vial is removed before a result is determined (i.e., premature removal of vial), an animated vial is displayed and the test time field below will change to a 20 second countdown or time-out period. If the vial is returned before the time-out period, testing will continue, if not, the well status will be replaced by a result of “?” and testing will cease. Replacement after the time-out period will initiate a new test sequence.

FIG. 14 and FIG. 15 illustrate one embodiment of well incubation initiation display screen 28. When a BI is first placed into a well, the system recognizes this process by filling in the well icon with a clock symbol and the test time of OH (zero hours) (indicated in FIG. 14 at well 6). The subline area will query the user to identify whether the biological indicator is a Control (unsterilized/unexposed) or a Test (sterilized/exposed) indicator. This “initiation screen” subline query stays in place until an input is keyed on the unit or through an external interface/database system. If “Control” is selected then the system will skip the following screens and the subline returns to the Temp/Unit screen. A ‘C” will replace the well number for the well containing the biological indicator encoded as a control, indicated in FIG. 15 at well 6.

If the user selects “TEST” as the BI type, then the “Predictor screen” subline query is initiated to prompt the user to document the response of any available early-readout prediction to the test BI, indicated in FIG. 16.

When PASS or FAIL is selected, this information is stored for this sample tied to the target well. This screen should hold for 15 seconds, then if no button is pressed/selected, it defaults to “inconclusive” in the “predictor” field.

FIG. 17 illustrates the sterilizer number identification screen display. “Sterilizer number identification screen” subline query is then documented based on which facility sterilizer the test biological indicator was sterilized in per industry guidance. The incubator accepts a two-digit ink identification from 1-99. Pressing the INC button will increment the highlighted field. The screen holds for 15-seconds until it defaults to a 1 in the sterilizer number field. Pressing NEXT will move to the next screen. If defaulted, the subline returns to the temp/unit screen.

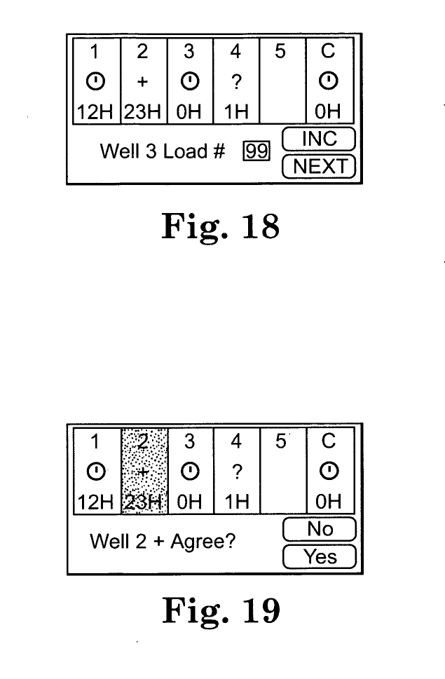

FIG. 18 illustrates one embodiment of the load number identification screen display. The “load number identification screen” subline query is documented based on which facility sterilizer load the test biological indicator was sterilized in per industry guidance. The incubator accepts a two-digit identification from 1-99. Pressing the INC button increments the highlighted field. Pressing NEXT moves to the next screen. The screen holds for 15-seconds until it defaults to a 1 in the load number field. If defaulted, the subline returns to the temp/unit screen. The Sterilizer Number and Load Number that is typically used as a clinical lot number (control number) per standard industry guidance.

Confirmation of Results: Once the testing on any active well is completed and the status section of the BI testing well boxes is populated by a “+”, “−”, or “?”, the system queries the user to input the acceptance of the final condition as a visual fail safe to the automated results determination, illustrated in FIG. 19.

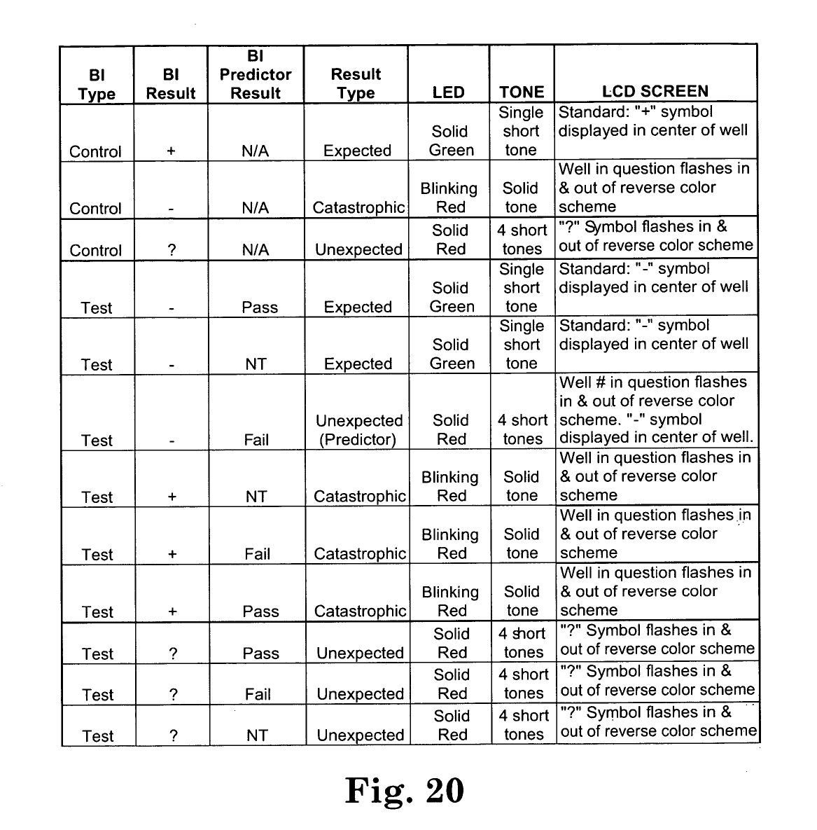

The system accepts a YES or NO response based on the button selection aligned with the appropriate highlighted answer. The screen will stay in place until an input is keyed on the unit or through an external interface/database system. FIG. 20 is a table illustrating results via the incubator displays and alarms. When the biological indicator incubation is complete, the results are compared with the expected results (from an early-readout predictor). FIG. 20 illustrates one embodiment of an outline of the results and the corresponding output, display or alarm (LED/tone) actions.

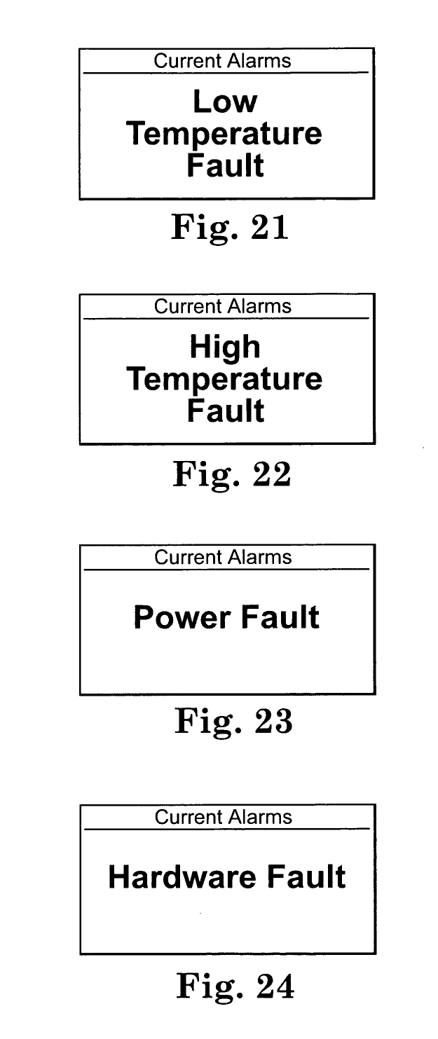

FIG. 21 and FIG. 22 illustrate one embodiment of display screens for temperature fault alarms. The incubator maintains the selected temperature during normal operation. If the incubator is unable to maintain the selected temperature within the failure/fault range (e.g., three degree see below the lower range limit), the unit will shut-down and display the temperature fault screen. The LED will flash red and an audible alarm will also sound a short tone to indicate this condition.

FIG. 23 is a diagram illustrating one embodiment of a power fault alarm display screen. When the incubator powers-up it monitors the temperature of the well block. If the temperature is within the selected operating range, and there are vials in the wells, the incubator will continue the timing operation. The assumption is that there was a short during power disruption.

If the incubator unit powers-up and the temperature is out of range, and there are vials in the wells, the power fault alarm will be displayed. The alarm will also sound a short tone periodically to indicate this condition. The alarm can be silenced by pressing the ALARM button (upper button).

FIG. 24 is a diagram illustrating one exemplary embodiment of a hardware fault alarm screen display. As the incubator is operating, it monitors its internal operation. If a hardware fault is detected, the incubator will shut-down and display the message “hardware fault”. The alarm will sound a short tone periodically to indicate this condition. The alarm can be silenced by pressing the ALARM button (upper button).

In one embodiment, the incubator unit is configured with an RS-232 serial port and a USB port. These ports allow data to be exchanged with an external interface device, such as a personal computer.
In one embodiment, the following output messages are generated automatically by the incubator:
1) Initial Read [I]: This message is sent once, when a BI is first inserted into a well.
Fields supported: MsgType [I]
   Unit ID
   Well #
   Test Time
   Test Result
2) Standard Read [R]: Message is sent every 5 minutes, or whenever a change in the well is detected.
Fields supported: MsgType [R]
   Unit ID
   Well #
   Test Time

Test Result

Message Structure

| Name | Max Length | Value |
|---|---|---|
| MsgType | 1 | I = Initial read |
| | | R = Standard Read |
| UnitID | 2 | Unit ID of incubator |
| Well# | 2 | Well # (1-12) |
| TestTime | 10 | Number of minutes past since |
| | | monitoring began |
| TestResult | 4 | −/+/?/ |

If a field is not supported, it will be empty
Field Separator: ,
End of Message Delimiter: Carriage Return & Line Feed [CrLf]
Sample Message: R, 1, 3, 45, ?[CrLf]

The following input messages can be generated through direct interface with the incubator unit, or through an external interfacing device, such. as a personal computer.
1) Initial Setup [S]
Fields Supported: MsgType [S]
   Unit ID
   Temp Set
   Clock
2) Load Information [L]
Fields Supported: MsgType [L]
   Unit ID
   Well #
   Test Type
   Sterilizer #
   Load #
   Predictor Result
   Finished
3) Query Unit ID (Q)
Incubator responds: MsgType [Q]

Unit ID

Message Structure

| | Max | |
|---|---|---|
| Name | Length | Value |
| MsgType | 1 | S = Initial Setup; |
| | | L = Load Info |
| Unit ID | 2 | Unit ID of incubator |
| Well # | 2 | Well # (1-12) |
| Date | 8 | YYYYMMDD |
| Time | 4 | HHMM |
| Temp Set | 10 | Steam or EO |
| Ster # | 2 | Sterilizer Number |
| Load # | 2 | Load Number |
| Test Type | 8 | Control or Test |
| Predictor | 4 | Pass or Fail |

If a field is not supported, it will be empty
Field Separator: ,
End of Message Delimiter: Carriage Return & Line Feed [CrLf]
Sample Message: S, 1, 3, STEAM, 20041005, 1200[CrLf]

Additional diagnostic messages are provided by the incubator. The diagnostic messages are used to get information for the purposes of testing and diagnostics. In one embodiment, the diagnostic messages include well database read, stream temperature, abort warm-up (abort warm-up and disable low temperature alarm), incubator mode, and disable read output.

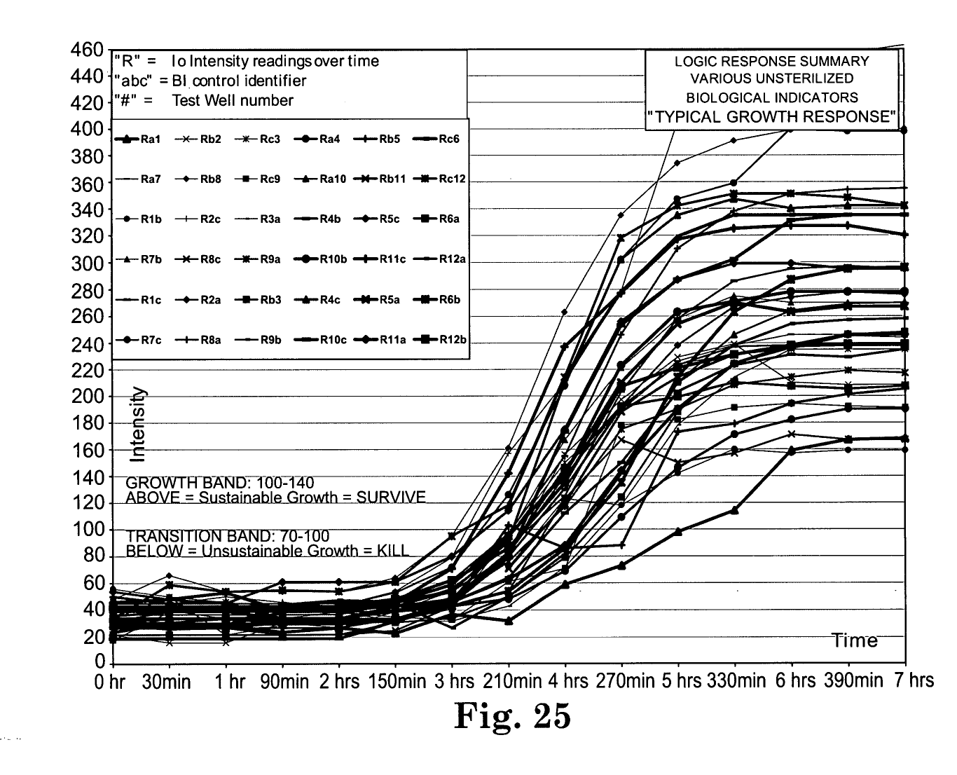

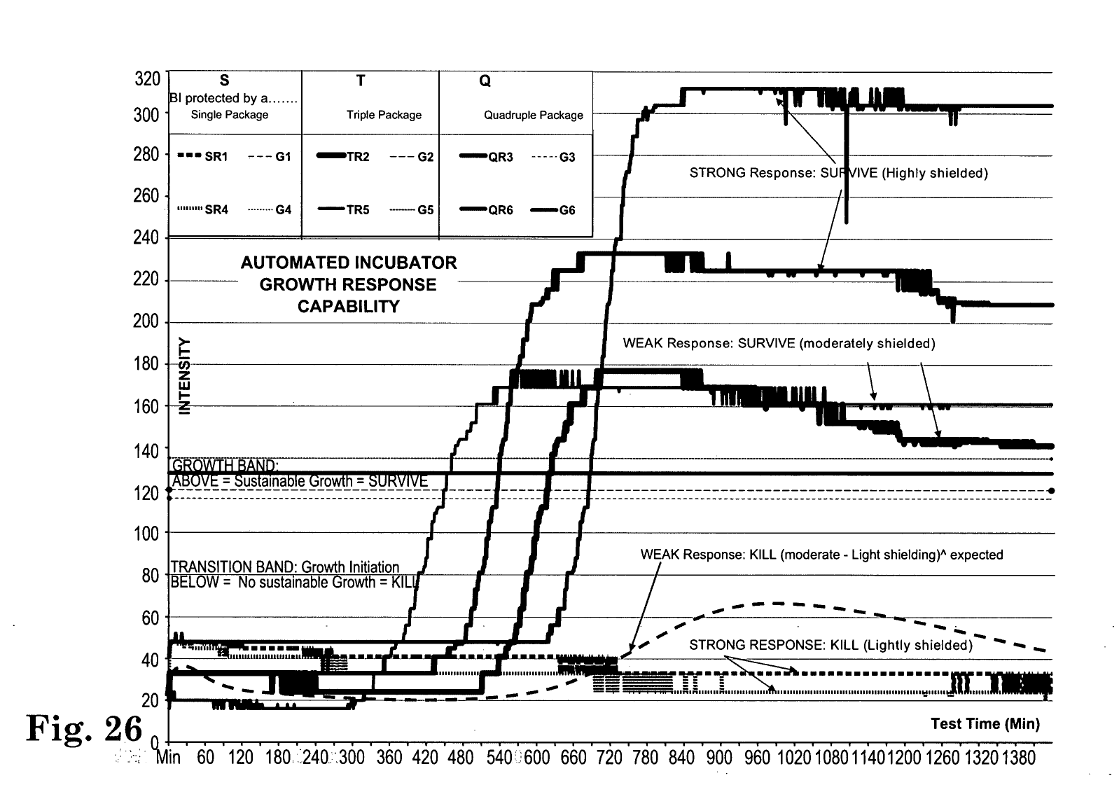

FIG. 25 is a graph illustrating one exemplary embodiment of biological indicator data output using an automated incubator system according to the invention. FIG. 26 is a graph illustrating one exemplary embodiment of the automated incubator growth response capability according to the invention. Reference is also made to FIG. 4.

In one embodiment, the incubator according to the invention is capable of determining characteristics of the biological indicator other than just successful sterilization. Incubator 20 provides output data to graphical user interface (GUI) 104 (e.g., a computer). In one embodiment, GUI 104 provides an output determining a SURVIVE or a KILL. In one embodiment, the output is in the form of a graph. A growth response graph is generated via GUI 104 using software. Alternatively, GUI 104 is integrated or part of with incubator 20.

In one embodiment illustrated in FIG. 26, the automated incubator is capable of determining/differentiating response levels other than a SURVIVE response or a KILL response. In one example embodiment, the present invention provides an output differentiating between a weak and strong survival, and a weak and strong kill. In one embodiment, a weak survival has a lower peak intensity reading during the indicator assessment, and the same intensity may degrade over the duration of incubation (e.g., 48 hours) signifying the lack of a viable population of spores. Accordingly, a weak kill may never visually indicate a long-term color change, but minor changes are detectable with the present invention as the injured spore population tries to grow (and change the fluid color) but never to a level determined by the system to reflect meaningful or sustainable growth. The graph of FIG. 26, generated via GUI 104, illustrates a STRONG SURVIVE, STRONG KILL, WEAK SURVIVE and a WEAK KILL.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An automated incubator suitable for incubating and reading a biological indicator comprising:
a test well;
a light source in communication with the test well;
a photo-detector in communication with the test well, having an output signal representative of light intensity incident on the photo-detector; and
a control system configured to receive the output signal and determine a sterility characteristic of a biological indicator positioned in the test well and a secondary characteristic of the biological indicator, using the output signal.

2. The incubator of claim 1, wherein the sterility characteristic is representative of a color of the biological indicator.

3. The incubator of claim 1, wherein the sterility characteristic is representative of a color change of the biological indicator.

4. The incubator of claim 1, wherein the secondary characteristic is representative of whether the biological indicator is positioned in the test well.

5. The incubator of claim 1, wherein the secondary characteristic is representative of how long the biological indicator has been positioned in the test well.

6. The incubator of claim 1, wherein an optical path is defined between the light source and the photo-detector, where the biological indicator positioned in the test well is positioned along the optical path.

7. The incubator of claim 1, comprising:
a unique identification code associated with the automated incubator.

8. The incubator of claim 7, comprising:
wherein the control system is configured to be programmable to receive the unique identification code.

9. The incubator of claim 1, comprising:
an output indication system coupled to the control system, configured to indicate the sterility characteristic of the biological indicator positioned the test well or the secondary characteristic of the biological indicator.

10. The incubator of claim 9, comprising:
wherein the output indication system includes a visual indicator.

11. The incubator of claim 9, comprising:
wherein the output indication system includes an audio indicator.

12. An automated incubator suitable for incubating and reading a biological indicator comprising:
a test well;
a heater positioned at the test well;
a chip temperature sensor in communication with the test well, the chip temperature sensor having a temperature output signal;
a light source in communication with the test well;
a photo-detector in communication with the test well, having an output signal representative of light intensity incident on the photo-detector; and
a heater positioned at the test well, the heater being operable to maintain a desired temperature of the test well based on the temperature output signal.

13. The incubator of claim 12, further comprising:
a control system configured to receive the output signal and determine a sterility characteristic of a biological indicator positioned the test well and a secondary characteristic of the biological indicator, using the output signal; and
wherein the control system is responsive to the temperature output signal, and configured communicate with the heater to maintain the desired temperature of the test well.

14. The incubator of claim 12, wherein the desired temperature is selectable to 37 degrees Celsius or 57 degrees Celsius.

15. The incubator of claim 12, comprising:
wherein the incubator is programmable to track test inputs and outputs.

16. The incubator of claim 15, wherein the control system is configured to track a control biological indicator positioned in a first test well versus a test biological indicator positioned in a second test well.

17. The incubator of claim 15, wherein the control system is configured to track a fail versus pass predictor result.

18. The incubator of claim 15, wherein the control system is configured to receive and store a unique sterilizer number.

19. The incubator of claim 15, wherein the control system is configured to receive and store a unique load number.

20. The incubator of claim 15, wherein the control system is configured to track a test initiation time.

21. The incubator of claim 20, wherein the control system is configured to track a test initiation date.

22. The incubator of claim 15, wherein the control system is configured to track test duration.

23. An automated incubator suitable for incubating and reading a biological indicator comprising:
a test well;
a light source in communication with the test well;
a photo-detector in communication with the test well, having an output signal representative of light intensity incident on the photo-detector; and
a control system configured to receive the output signal and determine a sterility characteristic of a biological indicator positioned the test well, including a continuous calibration system configured to periodically determine a full scale value based on the output signal without a biological indicator placed in the test well.

24. The incubator of claim 23, wherein the continuous calibration system periodically determines the full scale value at least once every second.

25. The incubator of claim 23, comprising:
a constant current source configured to control the current to the light source.

26. The incubator of claim 23, comprising:
a converter configured to scale the output signal.

27. The incubator of claim 26 comprising:
wherein the converter is an A/D converter configured to adjust the output signal to one of a defined number of scalable levels.

28. The incubator of claim 27, comprising:
a constant current source coupled to the light source, wherein the constant current source and the A/D converter are referenced to the same power source.

29. The incubator of claim 23, wherein the continuous calibration system is configured to average the output signal over several cycles.

30. An automated incubator suitable for incubating and reading a biological indicator comprising:
a plurality of test wells;
an optical detection system positioned at one or more test wells, each optical detection system comprising:
a light source in communication with the test well;
a photo-detector in communication with the test well, having an output signal representative of light intensity incident on the photo-detector; and
a control system configured to activate only one light source at a time, to determine a state of each test well.

31. The incubator of claim 30, wherein the control system is configured to activate each light source once within a desired time period.

32. The incubator of claim 30, comprising:
wherein the control system is configured to determine if a vial has been removed from a test well.

33. The incubator of claim 32, comprising:
the control system including a removal time period, wherein the vial removed from the test well is not returned to the test well within the removal time period, testing on the test well is ceased.

34. An automated incubator suitable for incubating and reading a biological indicator comprising:
a test well;
a light source in communication with the test well;
a photo-detector in communication with the test well, having an output signal representative of light intensity incident on the photo-detector; and
a control system configured to receive the output signal and determine a sterility characteristic of a biological indicator positioned the test well, including a strong response or weak response of the biological indicator.

35. The incubator of claim 34, wherein the strong response includes one of a strong kill or a strong survive.

36. The incubator of claim 35, wherein the weak response includes one of a weak kill or a weak survive.

37. The incubator of claim 34, comprising:
a communications interface for communicating test results to an external device.

38. The incubator of claim 34, comprising:
wherein the control system includes a user interface configured to receive the output signal and determine the sterility characteristic.

39. The incubator of claim 38, wherein the user interface is external to the automated incubator.

40. The incubator of claim 38, wherein the user interface is a graphical user interface.
